(19) United States
(12) Patent Application Publication
(10) Pub. No.: US 2013/0022750 A1
(43) Pub. Date: Jan. 24, 2013

(54) METHOD FOR TREATING THE SURFACE OF A DEVICE FOR DISPENSING A FLUID PRODUCT

(71) Applicants: Pascal Bruna, Sotteville Les Rouen (FR); Matthieu Laurent, Vaucresson (FR); Fabien Nekelson, Montigny le Bretonneux (FR); Sébastien Roussel, Soisy sur Seine (FR)

(72) Inventors: Pascal Bruna, Sotteville Les Rouen (FR); Matthieu Laurent, Vaucresson (FR); Fabien Nekelson, Montigny le Bretonneux (FR); Sébastien Roussel, Soisy sur Seine (FR)

(73) Assignee: VALOIS SAS, Le Neubourg (FR)

(21) Appl. No.: 13/515,673

(22) PCT Filed: Dec. 22, 2010
(86) PCT No.: PCT/FR10/52889

§ 371 Date: Sep. 28, 2012

(30) Foreign Application Priority Data
Dec. 23, 2009 (FR) 0959496

(51) Int. Cl. B05D 7/00; B05D 7/14; C25D 5/02

(52) U.S. Cl. 427/407.2; 205/122; 427/407.1; 427/409

(57) ABSTRACT

A treatment method for treating the surface of a fluid dispenser device, said method being characterized in that it comprises a step of using chemical grafting to form a thin film on at least one support surface of at least one portion of said device that is in contact with the fluid while said device is being actuated, said thin film having non-stick properties relative to said fluid.

The present invention relates to a surface treatment method for fluid dispenser devices.

Fluid dispenser devices are well known. They generally comprise: a reservoir; a dispenser member, such as a pump or a valve; and a dispenser head that is provided with a dispenser orifice. Alternatively, in a variant, the fluid dispenser devices may be inhalers including a plurality of reservoirs each containing an individual dose of powder or liquid, and means for opening and expelling said doses during successive actuations. Thus, such devices include numerous parts that come into contact with the fluid during actuation. There is thus the risk of the fluid remaining stuck or attached to one or more portions of the device before being dispensed to the user. This results in a dose being dispensed that is smaller than the theoretical dose, thereby creating serious problems, e.g. for treating attacks such as asthma attacks. The problems of sticking may occur at the reservoir(s) in particular, but they may also occur at the piston and in the pump chamber or in the valve member and the valve chamber. The same applies for pushers or dispenser heads.

All existing surface treatment methods present drawbacks. Thus, certain methods are suitable for use only on plane surfaces. Other methods impose a limited choice of substrate, e.g. gold.

Polymerizing molecules by plasma as described in applications WO 02/47829 and US 2007/0131226 is complex and requires the use of fluorinated or perfluorinated monomers, it is costly, and the coating layer obtained is difficult to control and presents problems of aging.

Likewise, polymerizing molecules by ultraviolet radiation is also complex and costly, and functions only with photosensitive molecules. The same applies for atom transfer radical polymerization (ATRP) that is also complex and costly. Finally, electrografting methods are complex and require support surfaces that are conductive.

An object of the present invention is to propose a surface treatment method that does not have the above-mentioned drawbacks.

In particular, an object of the present invention is to provide a surface treatment method that is effective, long-lasting, non-polluting, and simple to perform.

The present invention thus provides a treatment method for treating the surface of a fluid dispenser device, said method comprising the step of using chemical grafting to form a thin film on at least one support surface of at least one portion of said device that is in contact with said fluid while said device is being actuated, said thin film having non-stick properties relative to said fluid.

In an advantageous implementation, said grafting step comprises putting said surface that is in contact with the fluid into contact with a solution that includes at least one adhesive primer, said adhesive primer being a cleavable aryl salt, and at least one monomer or polymer selected from the group constituted by vinyl- or acrylic-terminated siloxanes.

Advantageously, said thin film is a polymeric film that includes silicone.

Advantageously, said silicone is a DM300 or DM1000 silicone.

Advantageously, said chemical grafting creates covalent bonds between the molecules of said thin film and said support surface. This creates a strong and long-lasting connection.

Advantageously, said chemical grafting is performed in an aqueous medium. This makes it possible to use chemistry that is non-polluting or green and that does not present any risk to the environment.

In an implementation, the cleavable aryl salt is selected from the group constituted by: aryl diazonium salts; aryl ammonium salts; aryl phosphonium salts; aryl sulfonium salts; and aryl iodonium salts.

The cleavable aryl salts are selected from compounds of general formula ArN₂⁺, X⁻ in which Ar represents the aryl group and X⁻ represents an anion. The aryl group in an organic compound is a functional group derived from an aromatic ring.

In an implementation, X⁻ anions are selected from: inorganic anions such as halides, such as I-, Cl-, and Br-; halogenoborates such as tetrafluoroborate; and organic anions such as alcoholates, carboxylates, perchlorates, and sulfonates.

In an implementation, the aryl groups Ar are selected from possibly mono- or poly-substituted aromatic or heteroaromatic groups constituted by one or more aromatic rings of 3 to 8 carbons. The heteroatoms of the heteroaromatic compounds are selected from N, O, P, and S. The substituents may contain alkyl groups and one or more heteroatoms such as N, O, F, Cl, P, Si, Br, or S.

In an implementation, the aryl groups are selected from: aryl groups substituted by attractor groups such as NO₂; COH; CN; CO₂H; ketones; esters; amines; and halogens.

In an implementation, the aryl groups are selected from the group constituted by: phenyl and nitrophenyl groups.

In an implementation, the cleavable aryl salt is selected from the group constituted by: phenyldiazonium tetrafluoroborate; 4-nitrophenyldiazonium tetrafluoroborate; 4-bromophenyldiazonium tetrafluoroborate; 4-aminophenyldiazonium chloride; 4-aminomethylphenyldiazonium chloride; 2-methyl-4-chlorophenyldiazonium chloride; 4-benzoylbenzenediazonium tetrafluoroborate; 4-cyanophenyldiazonium tetrafluoroborate; 4-carboxyphenyldiazonium tetrafluoroborate; 4-acetamidophenyldiazonium tetrafluoroborate; 4-phenylacetic acid diazonium tetrafluoroborate; 2-methyl-4-[(2-methylphenyl)diazenyl]benzenediazonium sulfate; 9,10-dioxo-9,10-dihydro-1-anthracenediazonium chloride; 4-nitronaphtalenediazonium tetrafluoroborate; and naphtalenediazonium tetrafluoroborate.

In an implementation, the cleavable aryl salt is selected from the group constituted by: 4-nitrophenyldiazonium tetrafluoroborate; 4-aminophenyldiazonium chloride; 2-methyl-4-chlorophenyldiazonium chloride; and 4-carboxyphenyldiazonium tetrafluoroborate.

In an implementation, the cleavable aryl salt concentration lies in the range 5×10⁻³ molar (M) to 10⁻¹ M.

In an implementation, the cleavable aryl salt concentration is about 5×10⁻² M.

In an implementation, the cleavable aryl salt is prepared in situ.

Advantageously, said chemical-grafting step is initiated by chemically activating a diazonium salt so as to form an anchor layer for said thin film.

Advantageously, said chemical-grafting step is initiated by chemical activation.

In an implementation, said chemical activation is initiated by the presence of a reducing agent in the solution.

In an implementation, the solution comprises a reducing agent.

The term “reducing agent” means a compound that donates electrons during a redox reaction. In an aspect of the present invention, the reducing agent presents a redox potential difference relative to the redox potential of the cleavable aryl salt, that lies in the range 0.3 volts (V) to 3 V.

In an aspect of the invention, the reducing agent is selected from the group constituted by: reducing metals that are possibly finely divided, such as iron, zinc, or nickel; a metal salt that is possibly in the form of a metallocene; and an organic reducing agent such as hypophosphorus acid, or ascorbic acid.

In an implementation, the reducing agent concentration lies in the range 0.005 M to 2 M.

In an implementation, the reducing agent concentration is about 0.6 M.

In an implementation, said thin film has a thickness that is less than 1 micrometer (μm), and that lies in the range 10 angstroms (Å) to 2000 Å.

In an implementation, said thin film has a thickness that is less than 1 μm, and that lies in the range 10 Å to 800 Å.

In an implementation, said thin film has a thickness that lies in the range 400 Å to 1000 Å.

The term “vinyl- or acrylic-terminated siloxane” means a saturated silicon and oxygen hydride that is formed with straight or branched chains of alternating silicon and oxygen atoms and including terminating vinyl or acrylic motifs.

In an implementation, vinyl- or acrylic-terminated siloxanes are selected from the group constituted by: vinyl- or acrylic-terminated polyalkylsiloxanes such as vinyl- or acrylic-terminated polymethylsiloxane; vinyl- or acrylic-terminated polydimethylsiloxane such as polydimethylsiloxane-acrylate (PDMS-acrylate); vinyl- or acrylic-terminated polyarylsiloxanes such as vinyl- or acrylic-terminated polyphenylsiloxane such as polyvinylphenylsiloxane; and vinyl- or acrylic-terminated polyarylalkylsiloxanes such as vinyl- or acrylic-terminated polymethylphenylsiloxane.

In an implementation, a potential difference is applied in said solution.

The term “potential difference” means the redox potential difference measured between two electrodes.

In an implementation, the potential difference is applied by a generator that is connected to two electrodes that are identical or different and that are dipped in the solution during the dipping step.

In an implementation, the electrodes are selected from: stainless steel; steel; nickel; platinum; gold; silver; zinc; iron; and copper; in pure form or in alloy form.

In an implementation, the electrodes are made of stainless steel.

In an implementation, the potential difference applied by a generator lies in the range 0.1 V to 2 V.

In an implementation, it is about 0.7 V.

In an implementation, the potential difference is generated by a chemical cell.

The term “chemical cell” means a cell that is made up of two electrodes that are interconnected via an ionic bridge. In an aspect of the present invention, the two electrodes are selected appropriately for the potential difference to lie in the range 0.1 V to 2.5 V.

In an implementation, the chemical cell is created between two different electrodes that are dipped in the solution.

In an implementation, the electrodes are selected from: nickel; zinc; iron; copper; and silver; in pure form or in alloy form.

In an implementation, the potential difference generated by the chemical cell lies in the range 0.1 V to 1.5 V.

In an implementation, the potential difference is about 0.7 V.

In an implementation, the electrodes are chemically isolated so as to avoid any contact between the substrate that is immersed in the solution and the electrodes that are also dipped in the solution.

Advantageously, the method further comprises the step of using chemical grafting to form a second thin film on said support surface, said second thin film preventing interactions between said support surface and said fluid.

In a first variant, said two thin films are deposited on said support surface during two successive chemical-grafting steps, each step being performed in a single-component bath.

In a second variant, said two thin films are deposited on said support surface simultaneously during a single chemical-grafting step in a multi-component bath.

Advantageously, said support surface is made of synthetic material, in particular comprising polyethylene and/or polypropylene.

Advantageously, said support surface is made of metal.

Advantageously, said thin film has a thickness that is less than 1 μm, preferably lying in the range 10 Å to 800 Å. No conventional coating technique makes it possible to obtain chemically-grafted layers that are as thin.

Advantageously, said dispenser device comprises: a reservoir containing the fluid; a dispenser member, such as a pump or a valve, that is fastened on said reservoir; and a dispenser head that is provided with a dispenser orifice, and this is for actuating said dispenser member.

In a variant, said dispenser device comprises: a plurality of individual reservoirs each containing a dose of fluid; reservoir opening means, such as a perforator needle; and dose dispenser means for dispensing a dose of fluid from an individual opened reservoir through a dispenser orifice.

Advantageously, said fluid is a pharmaceutical for spraying in nasal or oral manner.

In an implementation, it is possible to use a method similar to the method described in document WO 2008/078052, which describes a method of preparing an organic film on the surface of a solid support under non-electrochemical conditions. Surprisingly, that type of method turns out to be suitable for forming a thin non-stick film on surfaces that are movable during the actuation of the above-mentioned dispenser devices. Such an application of that grafting method has not previously been envisaged.

To summarize, the method seeks to prepare a thin film, in particular a film made of polyethylene and/or of polypropylene and/or of metal, on the surface of a solid support. The method mainly comprises putting said support surface into contact with a liquid solution. The liquid solution includes at least one solvent and at least one adhesive primer, enabling radical entities to be formed from the adhesive primer.

The “thin film” may be any polymeric film, in particular of organic nature, e.g. resulting from a plurality of units of organic chemical species, and bonded in covalent manner to the surface of the support on which the method is performed. In particular, it is a film that is bonded in covalent manner to the surface of the support, and that includes at least one layer of structural units of similar nature. Depending on the thickness of the film, its cohesion is provided by covalent bonds that develop between the various units. Preferably, the thin film contains silicone.

The solvent used in the context of the method may be of protic or aprotic nature. It is preferable for the primer to be soluble in said solvent.

The term “protic solvent” means a solvent that includes at least one hydrogen atom that is capable of being released in the form of a proton. The protic solvent may be selected from the group constituted by: water; deionized water; optionally-acidified distilled water; acetic acid; hydroxylated solvents such as methanol and ethanol; liquid glycols of small molecular weight such as ethyleneglycol; and mixtures thereof.

In a first variant, the protic solvent is constituted solely by a protic solvent or by a mixture of different protic solvents.

In another variant, the protic solvent or the mixture of protic solvents may be mixed with at least one aprotic solvent, it being understood that the resulting mixture should present the characteristics of a protic solvent.

Acidified water is the preferred protic solvent, and more particularly, acidified distilled water or acidified deionized water.

The term “aprotic solvent” means a solvent that is considered as not being protic. Under non-extreme conditions, such solvents are not suitable for releasing a proton or for accepting one. The aprotic solvent is advantageously selected from: dimethylformamide (DMF); acetone; and dimethyl sulfoxide (DMSO).

The term “adhesive primer” corresponds to any organic molecule that is suitable, under certain conditions, for chemisorbing onto the surface of the solid support by a radical reaction, such as radical chemical grafting. Such molecules include at least a functional group that is suitable for reacting with a radical, and also a reactive function that reacts with another radical after chemiabsorption.

Thus, after grafting a first molecule to the surface of the support, the molecules are capable of forming a polymeric film, and then of reacting with other molecules that are present in its environment.

The term “radical chemical grafting” refers, in particular, to the use of molecular entities that possess an unpaired electron in order to form bonds with the support surface of the covalent-bond type, said molecular entities being generated independently of the support surface onto which they are to be grafted. Thus, the radical reaction leads to covalent bonds being formed between the support surface under consideration and the derivative of the grafted adhesive primer, and then between a grafted derivative and molecules that are present in its environment.

The term “derivative of the adhesive primer” means a chemical unit resulting from the adhesive primer, after said adhesive primer has reacted by radical chemical grafting, in particular with the surface of the solid, or with another radical. To the person skilled in the art, it is clear that the function that is reactive with another radical after chemiabsorption of the derivative of the adhesive primer is different from the function involved in the covalent bonding, in particular with the surface of the solid support.

Advantageously, the adhesive primer is a cleavable aryl salt selected from the group constituted by: aryl diazonium salts; aryl ammonium salts; aryl phosphonium salts; aryl sulfonium salts; and aryl iodonium salts.

Preferably, the thin film includes silicone that may be of various medical grades, e.g. DM300 or DM1000. As a variant to the direct covalent bonds of the silicone on the support surface, as obtained in an aqueous medium, it is also possible to use a method of impregnating a porous layer that has previously been grafted with silicone.

In an advantageous implementation of the invention, chemical grafting is used to form at least a second thin film on a single support surface, so as to give at least one other property to the support surface. Thus, elastomer surfaces, and in particular the above-mentioned gaskets, metal or glass surfaces, or surfaces that are synthetic, e.g. made of polyethylene or of polypropylene, are at risk of interacting with the fluid, e.g. shedding extractables into said fluid, which may have a harmful effect on said fluid.

The invention advantageously makes provision for using chemical grafting to form a second thin film that prevents interaction between an elastomer surface and the fluid. The second thin film may be applied during a second chemical-grafting step. Each chemical-grafting step may then be performed in a single-component bath. It should be observed that the two successive chemical-grafting steps may be performed in any order. In a variant, the two thin films may alternatively be applied during a single chemical-grafting step that is thus performed in a multi-component bath. Optionally, other additional thin films may also be formed by chemical grafting, e.g. so as to limit friction between parts that move during actuation.

The invention also relates to the use of a grafting method of the invention in order to form a thin film on at least one surface of at least one component part of a fluid dispenser device that is in contact with said fluid while said device is being actuated, said thin film having non-stick properties relative to said fluid.

The following examples were performed in a glass vessel. Unless indicated to the contrary, they were performed under normal temperature and pressure conditions (about 22° C. under about 1 atmosphere (atm)) in ambient air. Unless mentioned to the contrary, the reagents used were obtained directly on the market without additional purification. The samples were subjected beforehand to washing under ultrasound in soapy water at 40° C.

### EXAMPLE 1

### Grafting a Poly(dimethylsiloxane) Film onto Parts of a Pump so as to Lubricate It

The term “pump” means a fluid dispenser device that is actuated manually, and that includes a pump body in which one or more pistons slide.

Vinyl-terminated poly(dimethylsiloxane) (1.0 gram (g), 5 grams per liter (g/L)) was poured into a solution of Brij® 35 (0.874 g at 4.37 g/L) in 70 milliliters (mL) of milliQ (mQ) water, then the suspension was stirred magnetically so as to form an emulsion.

4-aminobenzoic acid (1.370 g, 10⁻² moles (mol)) was dissolved in a solution of hydrochloric acid (4.0 mL in 120 mL of mQ water) and of hypophosphorus acid (6.3 mL, 6.0×10⁻² mol). That solution was added to the PDMS emulsion.

To that emulsion there were added 8 mL of an aqueous solution of NaNO₂ (0.667 g, 9.7×10⁻³ mol), and then the pump-part samples.

After 30 minutes of reaction, the samples, namely: a body made of PP; an upper piston; a lower piston; and a tube made of polyethylene PE; were removed, then rinsed in successive baths of soapy water (Renoclean) at 1% under ultrasound at 40° C., and baths of water.

After drying the parts with compressed air, the presence of PDMS on the samples was confirmed by infrared (IR) analysis by means of PDMS-specific bands at 1260 per centimeter (cm⁻¹), 1110 cm⁻¹, and 1045 cm⁻¹.

### EXAMPLE 2

### Grafting a Poly(dimethylsiloxane) Film onto Parts of a Valve so as to Lubricate It

The term “valve” means a fluid dispenser device that contains propellant gases, and that includes a valve body in which a valve member slides.

Sodium dodecyl benzene sulfonate (1.307 g, 0.015 M) was dissolved in 175 mL of mQ water. Vinyl-terminated poly(dimethylsiloxane) (2.5 g, 10 g/L) was added, then the mixture was stirred magnetically so as to form an emulsion.

4-aminobenzoic acid (3.462 g, 2.5×10⁻² mol) was dissolved in a solution of hydrochloric acid (9.6 mL in 20 mL of mQ water) and of hypophosphorus acid (33 mL, 3.1×10⁻¹ mol). That solution was added to the PDMS emulsion.

To that emulsion there were added 10 mL of a solution of NaNO₂ (1.664 g, 2.37×10⁻² mol) in mQ water, and then the samples, namely: ethylene propylene diene monomer (EPDM) or nitrile rubber gaskets; a valve member top made of polyoxymethylene (POM); and a gold indicator strip.

After 15 minutes of reaction, the samples were removed, then rinsed successively in mQ water, in ethanol, and in hexane.

The presence of PDMS on the gold strip and on the other samples was confirmed by IR analysis with PDMS-specific bands at 1260 cm⁻¹, 1110 cm⁻¹, and 1045 cm⁻¹.

### EXAMPLE 3

### Electrocatalyzed Chemical Grafting of a Polymer Film made of Acrylic-PDMS onto a Polyethylene Substrate

This example explains how to graft a lubricating coating (acrylic-PDMS) onto a thermoplastic such as PE.

The PE samples were washed in ethanol, under ultrasound (at 50% power, temperature at 40° C.) for 5 minutes.

The biphasic solution was prepared in two stages. The following were added to a beaker (1), in order and under magnetic stirring (at 300 revolutions per minute (rpm)): PDMS-acrylate (1 g/L); Brij® 35 in solution in water at 8.5% by weight (% wt) (4.37 g/L); and 33 mL of deionized (DI) water. Emulsification then took place under ultrasound at 40° C. and at a power of 200 watts (W) (100%) for 15 minutes.

The following were added to a beaker (2), under magnetic stirring (at 300 rpm): nitrobenzene diazonium tetrafluoroborate (0.05 mol/L); 130 mL of DI water; and hydrochloric acid (0.23 mol/L).

The content of beaker (2) was poured into the emulsion of beaker (1). The PE samples (×2); a winding of galvanized steel wire (ten turns, i.e. a length of about 25 centimeters (cm) to 30 cm); and a winding of nickel (Ni) wire (ten turns, i.e. a length of about 25 cm to 30 cm); were placed in beaker (1). The two wires were connected together and an ammeter was connected in series.

Finally, once the assembly was ready, hypophosphorus acid (0.7 mol/L) was added last, thereby marking the start of the reaction. After 30 minutes of reaction at ambient temperature, the PE samples were removed, then rinsed successively in water, in ethanol, and finally in isopropanol, in a soxhlet extractor for 16 hours.

The soxhlet was composed of: a glass body in which the sample was placed; a siphon-tube; and a distillation tube. The soxhlet was placed on a flask (specifically a 500 mL flask heated and stirred via a flask heater) containing the solvent (specifically 300 mL of isopropanol) and surmounted by a condenser.

When the flask was heated, the solvent vapor passed via the distillation tube, condensed in the condenser, and dropped back into the glass body, thereby soaking the sample in pure solvent (heated by the underlying vapor). The condensed solvent accumulated in the extractor until it reached the top of the siphon-tube which then caused the liquid to return to the vessel, accompanied by extracted substances, and the solvent contained in the vessel was thus enriched progressively with soluble compounds.

The solvent thus continued to evaporate, while the extracted substances remained in the vessel (their boiling temperature needs to be significantly higher than the boiling temperature of the extractor solvent).

The use of a soxhlet extractor made it possible to confirm the chemical grafting of acrylic-PDMS on the surface of the PE substrate.

An analysis by IR spectroscopy was performed. The infrared spectrum made it possible to confirm the grafting of acrylic-PDMS by the presence of the characteristic band at 1260 cm⁻¹ corresponding to the vibration of the Si—CH₃ bond.

### EXAMPLE 4

### Electrocatalyzed Chemical Grafting of a Polymer Film Made of Acrylic-PDMS onto a Polyethylene Substrate in the Presence of a Potentiostat

This example explains how to graft a lubricating coating (acrylic-PDMS) onto a thermoplastic such as PE in the presence of a potentiostat.

The PE samples were washed in ethanol, under ultrasound (power at 100 W, temperature at 40° C.) for 5 minutes.

The biphasic solution was prepared in two stages. The following were added to a beaker (1), in order and under magnetic stirring (at 300 rpm): PDMS-acrylate (1 g/L); Brij® 35 in solution in water at 8.5% wt (4.37 g/L); and 33 mL of DI water. Emulsification then took place under ultrasound at 40° C. and at a power of 200 W (100%) for 15 minutes.

The following were added to a beaker (2), under magnetic stirring (at 300 rpm): nitrobenzene diazonium tetrafluoroborate (0.05 mol/L); 130 mL of DI water; and hydrochloric acid (0.23 mol/L).

The content of beaker (2) was poured into the emulsion of beaker (1). The PE samples (×2); a winding of galvanized steel wire (ten turns, i.e. a length of about 25 cm to 30 cm); and a winding of Ni wire (ten turns, i.e. a length of about 25 cm to 30 cm); were placed in beaker (1). The two wires were connected to a potentiostat and an ammeter was connected in series. The potentiostat imposed a constant potential difference of 0.5 V and the current over time was measured by the ammeter.

Finally, once the assembly was ready, hypophosphorus acid (0.7 mol/L) was added last, thereby marking the start of the reaction. After 30 minutes of reaction at ambient temperature, the PE samples were removed, then rinsed successively in water (a cascade), then in ethanol (a cascade), and finally in isopropanol, in a soxhlet extractor for 16 hours.

The use of a soxhlet extractor made it possible to confirm the chemical grafting of acrylic-PDMS on the surface of the PE substrate.

An analysis by IR spectroscopy was performed. The IR spectrum made it possible to confirm the grafting of acrylic-PDMS by the presence of the characteristic band at 1260 cm⁻¹ corresponding to the vibration of the Si—CH₃ bond.

Various modifications may also be envisaged by a person skilled in the art, without going beyond the ambit of the present invention, as defined by the accompanying claims.

1. A treatment method for treating the surface of a fluid dispenser device, comprising a step of using chemical grafting to form a thin film on at least one support surface of at least one portion of said device that is in contact with the fluid while said device is being actuated, said thin film having non-stick properties relative to said fluid.

2. A method according to claim 1, wherein said grafting step comprises putting said surface that is in contact with the fluid into contact with a solution that includes at least one adhesive primer, said adhesive primer being a cleavable aryl salt, and at least one monomer or polymer selected from the group constituted by vinyl- or acrylic-terminated siloxanes.

3. A method according to claim 2, wherein vinyl- or acrylic-terminated siloxanes are selected from the group constituted by: vinyl- or acrylic-terminated polyalkylsiloxanes such as vinyl- or acrylic-terminated polymethylsiloxane; vinyl- or acrylic-terminated polydimethylsiloxane such as polydimethylsiloxane-acrylate (PDMS-acrylate); vinyl- or acrylic-terminated polyarylsiloxanes such as vinyl- or acrylic-terminated polyphenylsiloxane such as polyvinylphenylsiloxane; and vinyl- or acrylic-terminated polyarylalkylsiloxanes such as vinyl- or acrylic-terminated polymethylphenylsiloxane.

4. A method according to claim 1, characterized in that the cleavable aryl salt is selected from the group constituted by: aryl diazonium salts; aryl ammonium salts; aryl phosphonium salts; aryl sulfonium salts; and aryl iodonium salts.

5. A method according to claim 1, characterized in that said chemical-grafting step is initiated by chemical activation.

6. A method according to claim 5, characterized in that said chemical activation is initiated by the presence of a reducing agent in the solution.

7. A method according to claim 6, characterized in that the reducing agent is selected from the group constituted by: reducing metals that are possibly finely divided, such as iron, zinc, or nickel; a metal salt that is possibly in the form of a metallocene; and an organic reducing agent such as hypophosphorus acid, or ascorbic acid.

8. A method according to claim 1, characterized in that a potential difference is applied in said solution.

9. A method according to claim 8, characterized in that the potential difference is applied by a generator that is connected to two electrodes that are identical or different and that are dipped in the solution.

10. A method according to claim 8, characterized in that the potential difference is generated by a chemical cell.

11. A method according to claim 1, wherein the method further comprises the step of using chemical grafting to form a second thin film on said support surface, said second thin film preventing interactions between said support surface and said fluid.

12. A method according to claim 1, wherein said support surface is made of synthetic material, in particular comprising polyethylene and/or polypropylene.

13. A method according to claim 1, wherein said support surface is an elastomer, glass, or a metal.

14. A method according to claim 1, wherein said thin film has a thickness that is less than 1 μm, preferably lying in the range 10 Å to 2000 Å.

15. A method according to claim 1, wherein said dispenser device comprises: a reservoir containing the fluid; a dispenser member, such as a pump or a valve, that is fastened on said reservoir; and a dispenser head that is provided with a dispenser orifice, and this is for actuating said dispenser member.

16. A method according to claim 1, wherein said dispenser device comprises: a plurality of individual reservoirs each containing a dose of fluid;
reservoir opening means, such as a perforator needle; and dose dispenser means for dispensing a dose of fluid from an individual opened reservoir through a dispenser orifice.

17. A method according to claim 1, wherein said fluid is a liquid or powder pharmaceutical for spraying in nasal or oral manner.

18. The use of a grafting method according to claim 1, in order to form a thin film on at least one surface of at least one component part of a fluid dispenser device that is in contact with said fluid while said device is being actuated, said thin film having non-stick properties relative to said fluid
